(19) United States
(12) Patent Application Publication
(10) Pub. No.: US 2007/0099047 A1
(43) Pub. Date: May 3, 2007

(54) Regulated fuel cell device

(76) Inventor: Chun-Chin Tung, Taipei (TW)

Correspondence Address: G. LINK CO. LTD., 3550 BELL ROAD, MINOOKA, IL, 60447, US

(21) Appl. No.: 11/263,901

(22) Filed: Nov. 2, 2005

(51) Int. Cl. H01M 8/04

(52) U.S. Cl. 429/23; 429/26

(57) ABSTRACT

ABSTRACT The present invention relates to a regulated fuel cell device comprising: a substrate, a DC regulating circuit, a packaging device and a heat sink. The substrate is made of a printed circuit board material, and provided with at least one membrane electrode assembly. The DC regulating circuit is disposed on the substrate for receiving input voltage generated by the membrane electrode assembly and thus generating a steady DC output voltage. The packaging device is disposed on the substrate for covering the regulating circuit and preventing it from erosion of moisture and acidic substance. Furthermore, the DC regulating circuit is disposed on the substrate for saving the cost of the assembly. Through the combination of the packaging device and the heat sink, heat generated by the DC regulating circuit will be easily dissipated.

### FIELD OF THE INVENTION

This invention relates to a fuel cell device, particularly to a regulated fuel cell device being able to output steady DC voltage.

### BACKGROUND OF THE INVENTION

Conventional fuel cells use hydrogen containing fuel, such as methanol, to form a current circuitry after an oxido-reduction reaction, so as to generate electrical power. It is observed from the voltage vs. current curve of such fuel cells that, when the loading current increases, the voltage reduces dramatically. Therefore, there is a need of a highly effective regulating circuit so as to supply a steady output voltage.

FIG. 1A and FIG. 1B are schematic diagrams of a conventional DC regulating module 100, wherein the DC regulating module 100 includes a circuit board 110, at least one DC regulating control unit 120 and some passive units (130, 131), so as to transform an input voltage power into DC voltage power of various Volt levels. The DC regulating module 100 includes plural terminal 150 for supplying the steady DC voltage power to other circuit boards (not shown).

However, the fuel cell may also produce excessive moisture and a small amount of acidic substance after the generation of power by the chemical reaction. If an exposed regulating module 100 is used with the fuel cell, a permanent damage caused by short circuit from moisture or erosion of electronic components caused by acidic substances may arise. Thus, the DC regulating module 100 further includes a packaging device 140 for covering the DC regulating control unit 120 and passive units (130, 131) so as to protect the DC regulating control unit 120 and passive unit (130, 131). However, in the conventional regulating module 100, the plural terminals 150 are still easily eroded by moisture or acidic substance. Thus, an improvement is needed for the regulating circuit used in the conventional fuel cell.

### SUMMARY OF THE INVENTION

It is thus a primary object of this invention to provide a regulated fuel cell device being able to output a steady DC voltage.

It is another object of this invention to provide a regulated fuel cell device with reduced manufacturing cost by providing a regulating circuit on a substrate of the fuel cell.

It is a further object of this invention to provide a regulated fuel cell device, wherein the combination of the regulating circuit and a packaging device is able to insulate from erosion of moisture and acidic substances.

It is a further object of this invention to provide a regulated fuel cell device, where the combination of the regulating circuit and a packaging device increases the dissipation of heat generated by the DC regulating circuit.

According to one aspect of this invention, a regulated fuel cell device is provided, comprising a substrate, a DC regulating circuit and a packaging device. The substrate is made of a printed circuit board material and provided with more than one membrane electrode assembly. The DC regulating circuit is disposed on the substrate for receiving input voltage generated by the membrane electrode assembly and generating an output voltage through the DC regulating circuit. The packaging device is disposed on the substrate for covering the regulating circuit and excluding erosion caused by moisture and acidic substances.

### BRIEF DESCRIPTION OF THE DRAWINGS

These and other modifications and advantages will become even more apparent from the following detained description of a preferred embodiment of the invention and from the drawings in which:

FIG. 1A is a top plan view of a conventional DC regulating module;

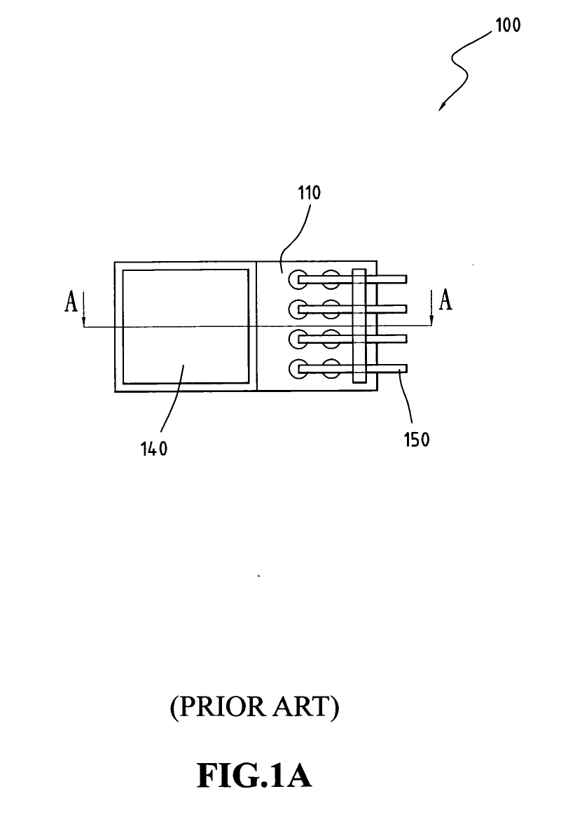

FIG. 1B is a side view of a conventional DC regulating module;

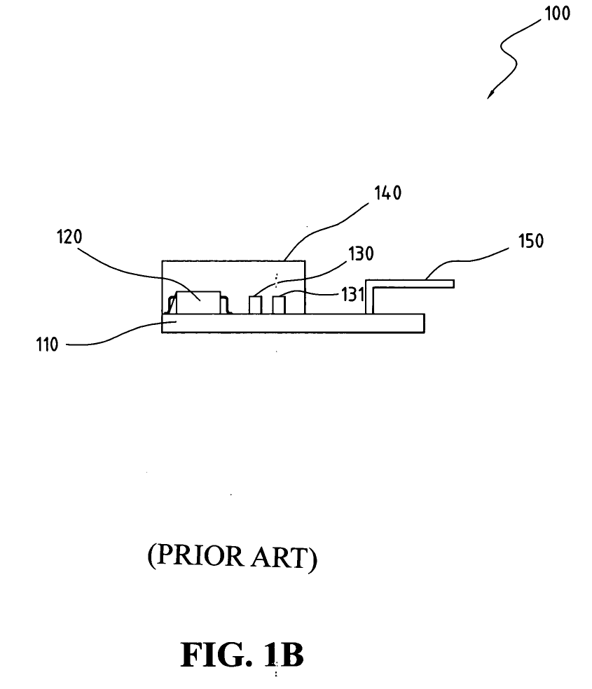

FIG. 2 is a side view of a regulated fuel cell device of this invention; and

FIG. 3 is a side view of another embodiment of the regulated fuel cell device of this invention.

### DETAILED DESCRIPTION OF THE INVENTION

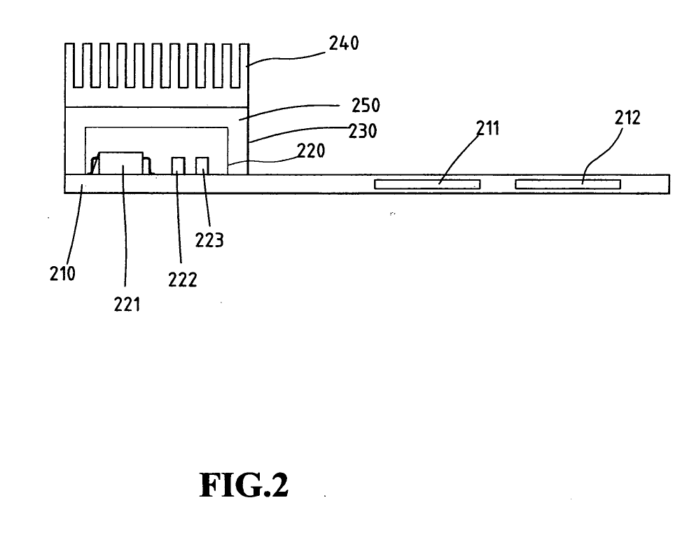

FIG. 2 is a side view of a regulated fuel cell device 200 of this invention. The fuel cell device 200 includes a substrate 210, a DC regulating circuit 220, a packaging device 230, a seal 250 and a heat sink 240. In the regulated fuel cell device 200 of this invention, the DC regulating circuit 220 is directly set on the substrate 210 for receiving a low level DC power generated by the fuel cell device 200 and discharging a steady output voltage, so as to regulate the fuel cell device 200.

The substrate 210 is made of a printed circuit board material and provided with more than one membrane electrode assembly (211, 212). The membrane electrode assembly (211, 212) serves to perform electrochemical reaction for converting chemical energy into a low level DC power.

The DC regulating circuit 220 is disposed on the substrate 210 for receiving an input voltage generated by the membrane electrode assemblies (211, 212) and generating an output voltage through the DC regulating circuit 220. The DC regulating circuit 220 includes a DC regulating integrated circuit 221 and passive units (222, 223) for converting an input voltage power into DC voltage power of various Volt levels. The output voltage may be at a level of +1.8 Volts, +3.3 Volts, +5 Volts and +12 Volts depending on the desired applications.

The packaging device 230 is disposed on the substrate 210 and serves to cover the regulating circuit 220 for preventing membrane electrode assemblies (211, 212) from erosion caused by moisture and acidic substances produced by the electro-chemical reaction.

To enhance the heat dissipating effect, a seal 250 is injected between the packaging device 230 and the regulating circuit 220. The seal 250 may be an adhesive with good hear-conductivity containing aluminum oxide injected into the packaging device 230 for encapsulating the DC regulating circuit 220. By the injection of the seal 250 with good heat-conductivity between the packaging device 230 and the regulating circuit 220, heat generated by the regulating circuit 220 can be effectively conducted to the packaging device 230.

In this embodiment, the packaging device 230 is made of a metal material, such as aluminum alloy. In other embodiments, the packaging device 230 may be made of a metal or alloy of silver, copper or steel.

The heat sink 240 is set on the packaging device 230 for dissipating heat generated by the DC regulating circuit 220. The heat sink 240 can be fastened onto the packaging device 230 or bonded onto the packaging device 230 by means of an adhesive agent with good heat-conductivity.

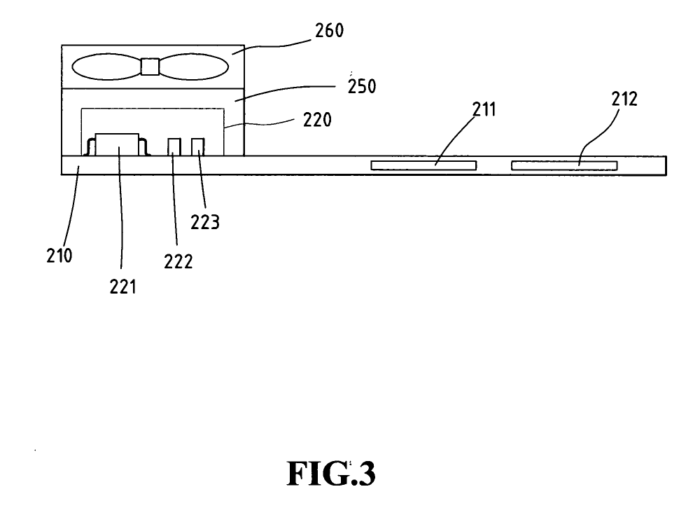

FIG. 3 is a side view of another embodiment of the regulated fuel cell device 200 of this invention. The feature that differs from that in FIG. 2 is, instead of the heat sink 240, a fan 260 is used to improve the heat dissipating capability.

It is known from the above description that, as methanol fuel cell not only produces power after chemical reaction, but also generates excessive moisture and a small amount of acidic substance. Accordingly, if an exposed regulating circuit is used in a methanol fuel cell, a permanent damage caused by short circuit from moisture, or erosion of electronic components caused by acidic substances may arise. In view of such properties of the methanol fuel cell, this invention uses an adhesive to package all components of the regulating circuit, so as to insulate from erosion by moisture and acidic substances. At the same time, the fuel cell device is able to output steady DC voltage. Furthermore, through the combination of the DC regulating circuit 220 and the substrate 210 of the fuel cell device 200, manufacturing cost is reduced. And through the combination of the packaging device 230 and heat sink 240, heat generated by the DC regulating circuit 220 is dissipated effectively.

This invention is related to a novel creation that makes a breakthrough in the art. Aforementioned explanations, however, are directed to the description of preferred embodiments according to this invention. Since this invention is not limited to the specific details described in connection with the preferred embodiments, changes and implementations to certain features of the preferred embodiments without altering the overall basic function of the invention are contemplated within the scope of the appended claims.

What is claimed is:

1. A regulated fuel cell device, comprising:
a substrate made of a printed circuit board material and provided with more than one membrane electrode assembly;
a DC regulating circuit disposed on the substrate for receiving an input voltage generated by the more than one membrane electrode assembly and generating an output voltage through the DC regulating circuit; and
a packaging device disposed on the substrate for covering the regulating circuit.

2. The fuel cell device of claim 1, further comprising a seal injected into the packaging device for encapsulating the DC regulating circuit.

3. The fuel cell device of claim 2, wherein the seal is an adhesive with good heat-conductivity containing aluminum oxide.

4. The fuel cell device of claim 1, wherein, the packaging device is made of metal material.

5. The fuel cell device of claim 4, further comprising a heat sink disposed on the packaging device for dissipating heat generated by the DC regulating circuit.

6. The fuel cell device of claim 4, further comprising a fan disposed on the packaging device for dissipating heat generated by the DC regulating circuit.

7. The fuel cell device of claim 1, wherein the output voltage is a DC voltage.

8. The fuel cell device of claim 7 wherein, the output voltage is at a level of +3.3 Volts.

9. The fuel cell device of claim 7, wherein the output voltage is at a level of +5 Volts.

10. The fuel cell device of claim 7, wherein the output voltage is at a level of +12 Volts.

11. The fuel cell device of claim 7, wherein the output voltage is at a level of +1.8 Volts.
